(19) United States
(12) Patent Application Publication
(10) Pub. No.: US 2013/0037629 A1
(43) Pub. Date: Feb. 14, 2013

(54) Water hose nozzle

(71) Applicant: Barry Boquet, Thibodaux, LA (US)

(72) Inventor: Barry Boquet, Thibodaux, LA (US)

(21) Appl. No.: 13/136,697

(22) Filed: Aug. 8, 2011

(51) Int. Cl. B05B 1/32

(52) U.S. Cl. 239/456

(57) ABSTRACT

A spray nozzle is designed for attachment to a water hose for watering lawns or gardens. The nozzle has a two-part construction with a main body and a tip member partially enclosing a portion of the main body. A stem of the main body carries a valve element, which is contoured to cooperate with the tip member and close an outlet opening of the nozzle. The tip member is threadably attached to the main body using quad-lead stem, such that a quarter turn of the tip member changes the flow pattern of the water flow from the nozzle from fully on to fully off.

### BACKGROUND OF THE INVENTION

This invention relates to nozzles, and more particularly to a nozzle configured for attachment to watering garden hoses and the like for use in watering a lawn or garden. Many people who water their lawns and gardens do so using a hose with an attached liquid connector, such as a spray nozzle. The industry has developed a number of such connectors. Some of the nozzles are formed as pistol-grip devices, with a clip that must be either continuously squeezed or locked in position to keep the internal valve open. Other types of gardening water nozzles are twist nozzles, where the user rotates the nozzle barrel or spray head to open the valve. Both types of nozzles are manufactured from a variety of materials, such as plastic, metal, alloys, and other non-corrosive materials.

In using a water hose to spray a lawn or garden, it is often desirable to adjust the spray between a concentrated full flow spray and a widely dispersed spray. Conventional spray nozzles provide such a wide range of spray patterns. By selecting one of a plurality of spray patterns, the nozzle may be used to create a jet of water that may be projected to spray water a long distance, a mist spray, a gentle soaking spray, and/or other spray patterns. To switch between the spray patterns the user usually rotates the nozzle barrel or a spray head in a plurality of incremental steps. Usually, such adjustment requires that the user use both hands—one holding the handle, and the other gradually rotating the barrel or the spray head. In either instance, the users have to rely on their ability to manually control the spray pattern.

The conventional watering spray nozzles often suffer from leak problems, where the flow of water is diverted to a leak, thus decreasing the pressure in the water line and the ability of the water flow to reach distant plantings. Even without a leak, the internal construction of many conventional spray nozzles diminishes the water pressure. As a result, the user has to move the hose closer to the plantings and drag the entire hose across the lawn or garden.

The present invention contemplates elimination of drawbacks associated with conventional watering spray nozzles and provision of an improved spray nozzle which can readily and reliably be locked in any of a number of spray patterns.

### SUMMARY OF THE INVENTION

It is, therefore, an object of the present invention to provide a watering spray nozzle that can be adjusted to create a variety of flow patterns.

It is another object of the invention to provide a watering spray nozzle that can be easily adjusted between a closed position, a full flow position and a variety of intermediate flow patterns.

It is a further object of the invention to provide a watering water spray that is configured to deliver a full water flow to a location at substantial distance from the user.

These and other objects of the invention are achieved through a provision of a spray nozzle designed for attachment to a water hose for watering lawns or gardens. The nozzle has a two-part construction with a main body and a tip member substantially enclosing a stem member of the main body. The stem of the main body carries a valve element, which is contoured to cooperate with the tip member and close an outlet opening of the nozzle. The tip member is threadably attached to the main body using quad-lead stem, such that each quarter turn of the tip member changes the flow pattern of the water flow from the nozzle from fully on to fully off. The tip member can be rotated using the same hand, which holds the nozzle main body. The nozzle can be readily secured with the water hose using a quick disconnect attachment.

### BRIEF DESCRIPTION OF THE DRAWINGS

Reference will now be made to the drawings, wherein like parts are designated by like numerals, and wherein

FIG. 1 is a sectional view of the nozzle according to this invention in a closed position.

FIG. 2 is a sectional view of the nozzle according to this invention in a partially open position producing a wide conical stream spray pattern.

FIG. 3 is a sectional view of the nozzle according to this invention in a partially open position producing a straight stream spray pattern.

FIG. 4 is a detail sectional view of the nozzle main body.

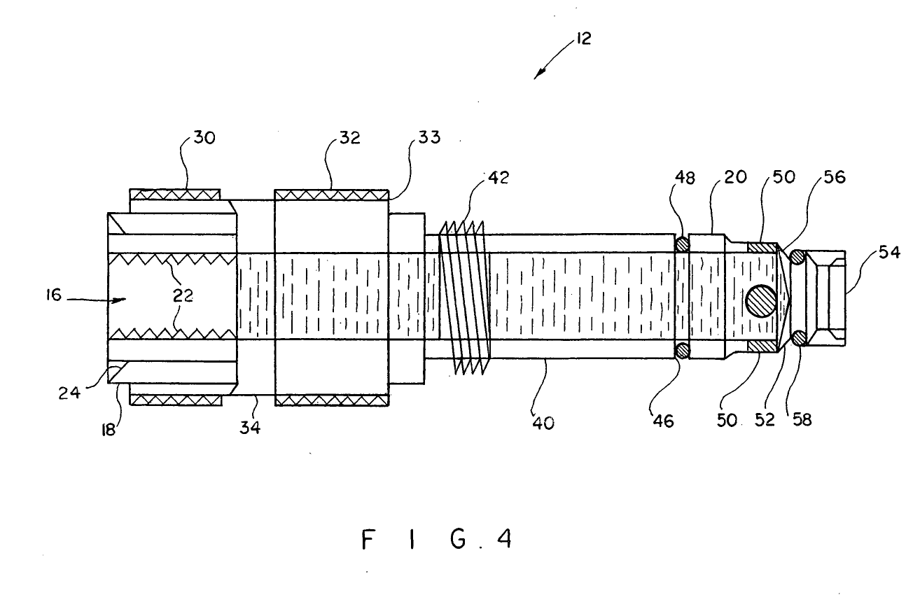

FIG. 5 is a detail sectional view of the nozzle main body with an optional quick connect/disconnect water hose attachment.

FIG. 6 is a detail sectional view of the nozzle tip portion.

### DETAIL DESCRIPTION OF THE INVENTION

Turning now to the drawings in more detail, numeral 10 designates the water hose nozzle device according to the present invention. The device 10 comprises a main body 12 and a tip member 14 theadably detachably engageable with the main body. The main body is provided with a central through opening 16, which extends longitudinally along the central axis of the body 12 from a first connector end 18 to a second outlet end 20. The central opening 16 has a substantially uniform diameter from the inlet end to the outlet end.

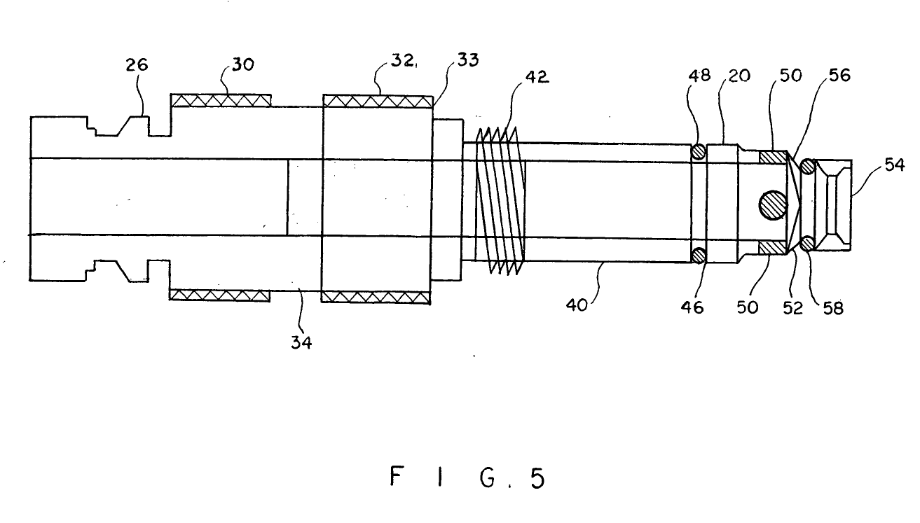

The inlet end 18 is configured for connection to a water hose (not shown). Water hose threads 22, which start at a distance from a first end face 24 of the main body 12. Alternatively, the main body 12 can be provided with a quick connect/disconnect attachment 26 (FIG. 5) engaged with the inlet end 18. The attachment 26 allows a one-step connect and disconnect from the water hose.

A first gripping portion 30 is formed on an exterior surface of the main body 12. The first gripping portion 30 has an exterior surface carrying a plurality of small ridges and grooves to facilitate gripping engagement by hands. The knurled surfaces can extend, in one exemplary embodiment, for about 0.5″ from the first end face 24 toward the second end 20. A second gripping portion 32 is formed a distance from the first gripping portion 30 and occupy about 1.25″ along the length of the main body 12. Similarly to the first gripping portion 30, the second gripping portion is provided with knurled outer surface of increased friction for easy gripping.

A reduced diameter intermediate portion 34 separates the first gripping portion 30 from the second gripping portion 32. The intermediate portion 34 may have smooth exterior surface. If desired, the end 36 of the first gripping portion 30 may be cut at an angle of about 45-degrees for a smooth transition between the first gripping portion 30 and the intermediate portion 34. A similar feature may be provided on the opposing face of the second gripping portion 43, if desired. A reduced diameter circumferential shoulder 33 is formed on the second gripping portion 32.

A nozzle stem member 40 is unitary secured to the circumferential shoulder 33. The nozzle stem member 40 has a significantly smaller diameter than the gripping portion 30, 32 and the intermediate portion 34. A plurality of quad-lead threads 42 is formed on the exterior of the nozzle stem member 40. The quad-lead thread system member has four threads wrapping around the shaft nozzle stem member 40 and four starting points. Such system member is different from a standard thread system member employed in conventional spray nozzles, where there is just one thread that wraps around a shaft. The quad-lead exterior threads 42 are configured for engagement with matching inner threads on an interior of the tip member 14, as will be described in more detail hereinafter, and allow the tip member 14 to travel four times as far with the same radius of turn. As a result, the change of the flow pattern can be achieved four times faster as compared to conventional spray nozzles. In one aspect of the invention, the threads 42 have 0.875OD with 12 pitch 4 lead of UN class 2B.

The threads 42 start a distance from the second gripping portion, as can be seen in the drawings. The distance can vary, and in one aspect of the invention a distance of 0.25″ was selected. The threads 42 extend for about 0.5″ along the length of the stem member 40. A first O-ring groove 46 is formed a distance from the threads 42 and closer to the outlet end 20 of the main body 12. A first O-ring 48 is fitted in the groove 46 to prevent leaks during operation of the nozzle 10.

A plurality of exit ports 50 is formed in the wall of the outlet end 20 of the main body 12 located in fluid communication with the central opening 16. In one aspect of the invention, there are five such outlet ports 50 equidistantly spaced around the circumference of the outlet end 20. The exit ports 50 can be 0.2″ in diameter. The multiple ports are designed to increase water flow into the tip cavity, which will result in greater water flow pressure compared to conventional spray nozzles.

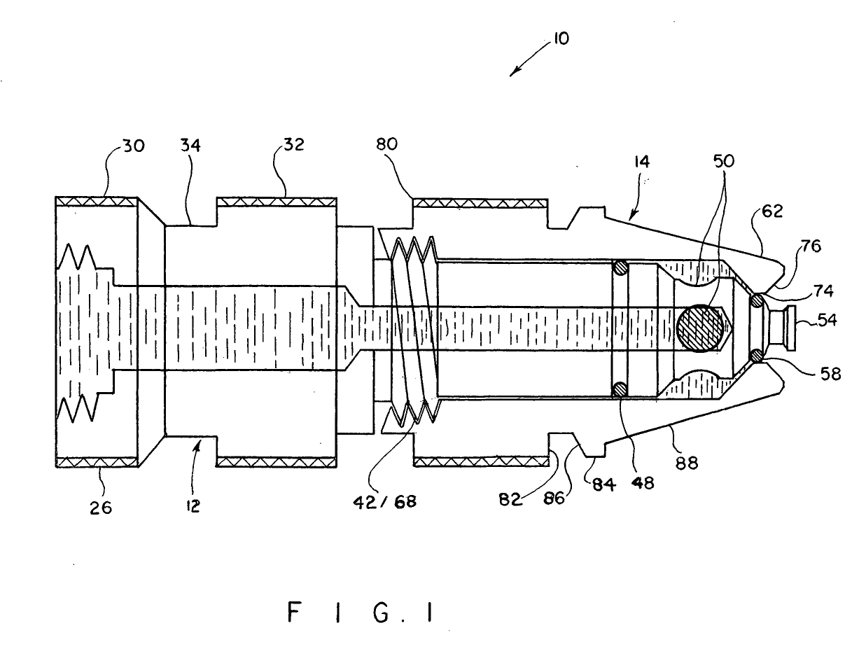

The outlet end 20 is provided with a conical forward part 52 and a closing member 54 unitary connected to the conical forward part 52. A second O-ring groove 56 is formed at the interface between the closing member 54 and the forward conical part 52. A second sealing O-ring 58 is fitted in the second O-ring groove 56. The second O-ring 58 seals the area around the closing member 54 and prevents escape of water when the nozzle is in a closed position shown in FIG. 1.

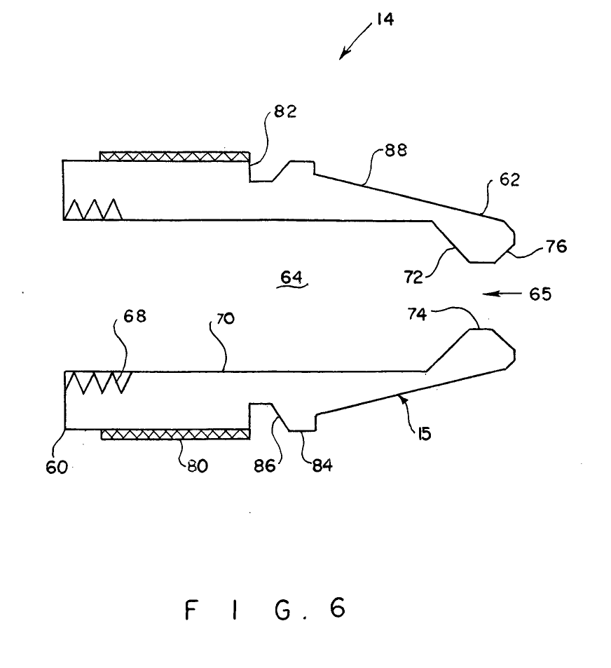

The nozzle tip member 14 of the device 10 is shown in detail in FIG. 6. The tip member 14 comprises a hollow body 15 having a first tip open end 60 and a second tip open end 62. The tip member 14 extends over substantially entire length of the stem member 40 forming a sleeve, which fricitonally engages the stem member 40 along majority of the length of the stem member 40. The body 15 defines a cavity 64, which extends from the first tip end 60 to the second tip open end 62. A plurality of quad-lead circumferential threads 68 is formed on an inner surface 70 of the tip body 15. The pitch and number of the inner threads 68 of the tip member 14 matches the pitch and number of the external threads 42 formed on the main body 12. The tip member 14 is detachably theadably engageable with the main body 12 via the threads 68, 42. The user may wish to disengage the tip member 14 from the main body 12 in order to clean the ports 50 or for other reason.

The inner cavity 64 of the tip member 14 is formed by a first part defined by a generally cylindrical portion of the inner wall 70. A forward, distant part of the cavity 64 narrows into a channel 65, the diameter of which is at least slightly greater than the exterior diameter of the conical forward part 52. A second part of the inner wall 70 is defined by an inner conical wall 72, which has an inclined angle adjacent the second tip open end 62. The inclined angle of the second part of the inner wall 70 matches the inclined angle of the conical forward part 52 of the main body 12. An inwardly oriented closing lip 74 extends toward the imaginary center axis of the cavity 64, reducing the diameter of the second tip open end 62. The closing lip 74 extends in a parallel relationship to the imaginary longitudinal axis of the cavity 64.

When the nozzle 10 is in a closed position, as shown in FIG. 1, the closing lip 74 frictionally contacts the second O-ring 58 and prevents water from escaping from the nozzle 10. The interaction between the second O-ring 58 and the closing lip 74 forms the valve of the device 10, preventing escape of water from the device 10. In the closed position, the closing member 54 is located forwardly of the closing lip 74, as shown in FIG. 1. The inner wall 70 also has a third part defined by an outwardly flaring forward end 76, which is unitary formed with the closing lip 74. The outwardly flaring forward end 76 surrounds the closing member 54 and protects the closing member 54 from damage.

The exterior surface of the tip member 14 is provided with a knurled gripping portion 80 formed adjacent the first open end 60. A forward circumferential shoulder 82 is formed forwardly of the tip gripping portion 80. A circumferential flange 84 is formed on the outer wall of the tip member 14, the flange 84 being separate from the shoulder 82 by a circumferential groove 86. A forward part 88 of the tip member 14 resembles a truncated cone, with the apex of the cone being adjacent the second tip open end 62. Except for the high-friction gripping portion 80, the outer surface of the tip member 14 can be formed smooth.

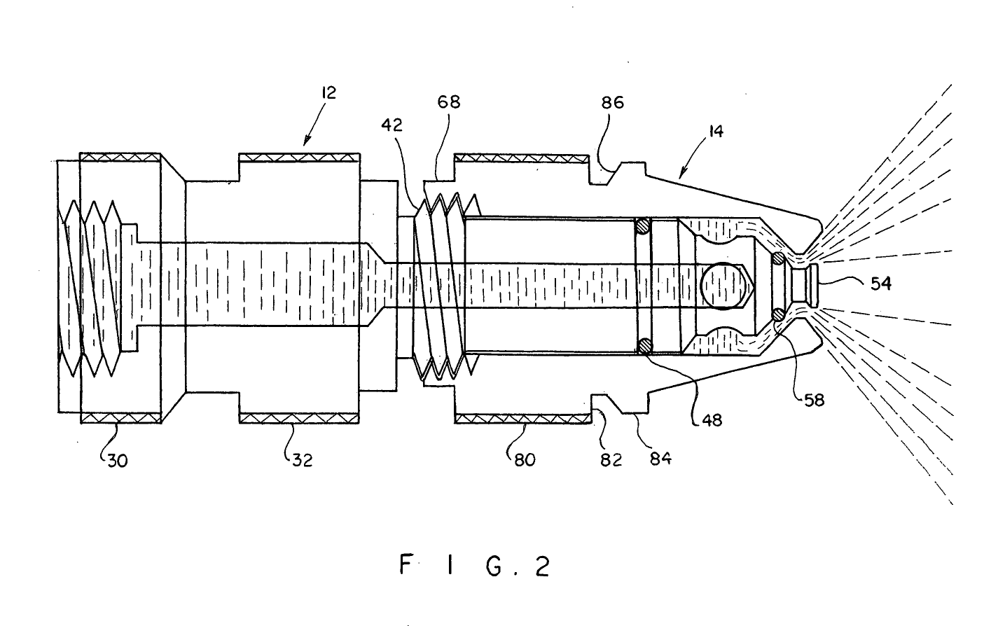

In operation, the user connects the main body 12 with an externally threaded end of a water hose using the internal threads 22 on the connector end 18. The user then opens the main valve of the water line through the water hose and applies rotation to the tip member 14. The user turns the tip member 14 about 90 degrees, or ¼ turn, moving the threads 68 to a position shown in FIG. 2. The main body 12 is retracted into the channel 65 breaking the sealing engagement between the second O-ring 58 and the inner conical wall 72 of the tip member 14. The rotation of the tip member 14 can be done using the same hand, which holds the main body 12.

The length of the stem member 40 is such that when the valve is closed, the tip end extends some distance from the opening defined by the closing lip 74. However, when the stem member is retracted away from the opening (i.e., from a first position in which the valve stem member blocks the opening and prevents water from being discharged from the nozzle) the closing member 54 is drawn toward the closing lip 74, which opens the channel 65 to the water flow from the water hose. Water is allowed to escape from the ports 50 into the channel 65 and then out of the nozzle 10. In this position, the nozzle 10 creates a conical water flow pattern schematically shown in lines 78 in FIG. 2. The flow pattern is dictated by the shape of the outwardly flaring forward end 76 of the tip member 14. At the same time the stem member 40 is frictionally engaged with the inner wall 70 of the tip member 14, and the first O-ring 48 prevents back flow of water.

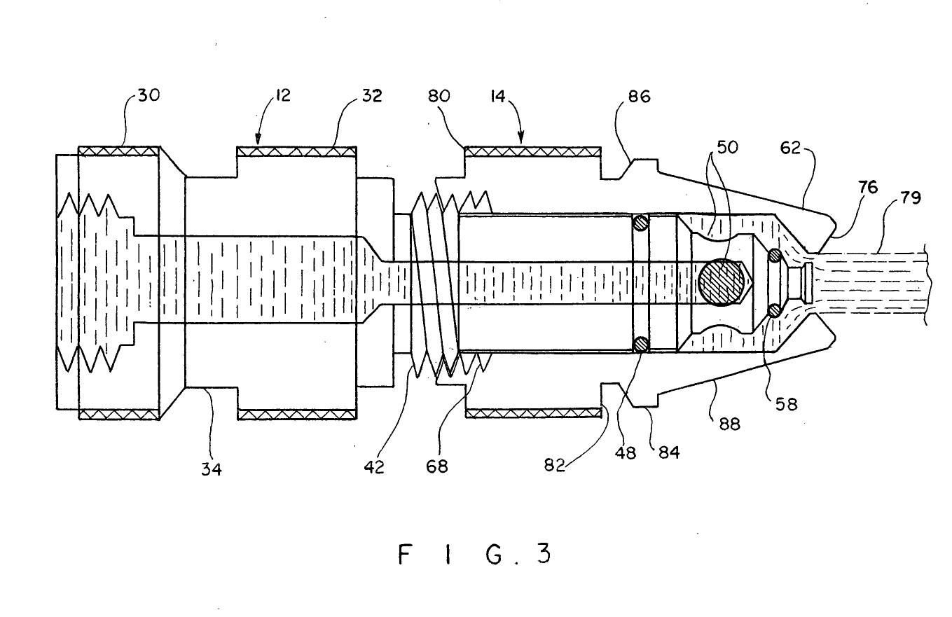

When the user applies more rotation to the tip 14, the threads 68 move further along the threads 42 such that the tip member 14 moves in a forward direction in relation to the main body 12, opening the channel 65 to a greater degree. A different flow pattern 79 is produced, as schematically shown by arrows 79 in FIG. 3. This flow pattern is dictated by the shape and size of the channel defined by the closing lip 74. Since the channel formed by the closing lip 74 is narrower than the diameter of the forward end 76 of the tip 14, a narrower flow of water escapes from the channel 65. As a result, the water pressure is greater, and the water flow reaches more distance, with greater strength than the water flow exiting between the outwardly flaring forward end 76. The water flow pattern can be incrementally modified by each ¼ turn of the quad-lead threads 42, 68.

In one aspect of the invention, the main body 12 is about 4-4.5″ in length and 1.0-1.2″ in the largest outer diameter portion. The stem member 40 is about 2 0 2.5″ long and 0.7-0.72″ in outer diameter. The tip member 14 can be about 2″ long and 1.0-1.2″ in it largest outer diameter portion. It will be understood that the device dimensions listed above are for exemplary purposes only and other dimensions can be used when manufacturing the device 10. In the preferred embodiment, the tip member 14 substantially covers the stem member 40. The nozzle device 10 can be manufactured from a variety of non-corrosive sturdy materials, including stainless steel.

The present invention allows the user to operate the nozzle 10 between closed and open positions in one quarter of a turn and vice versa, open-to-closed, in one quarter of a turn. This automatically dictates a change in the water flow pattern. The quad-lead threads allow the tip member 14 to move four times the distance compared to a single thread in 1 revolution. The nozzle is readily attached to the end of the hose using the quick disconnect attachment and is operable to spray water when a manually controlled valve of the spray nozzle is opened. The nozzle is controllable to produce spray patterns ranging from a very concentrated pattern to a widely dispersed pattern. The nozzle can be operated using one hand in applying rotation to the tip segment. The threads allow the user to easily lock the device in a desired spray pattern without the need to continuously squeeze a clip of a pistol-type nozzle.

Many changes and modifications can be made in the design of the present invention without departing from the spirit thereof. I, therefore pray that my rights to the present invention be limited only by the scope of the appended claims.

1. A spray nozzle device attachable to a water hose or the like, comprising:
a main body having a central opening extending therethrough, said body having a first connector end configured for attachment to the water hose and establishing fluid communication between the water hose and the central opening, a second outlet end, and a stem member formed between the first connector end and the second outlet end, said stem member being provided with a plurality of circumferentially spaced exit ports formed in fluid communication with the central opening, an exterior surface of the main body carrying a plurality of exterior threads;
a tip member comprising a hollow body having a first tip open end and a second tip open end, said hollow body defining a cavity, which extends from the first tip open end to the second tip open end defining a fluid channel in at least a part thereof, an inner wall of the hollow body carrying a plurality of inner threads adjacent the first tip open end, said inner threads being configured to matchingly engage with the exterior threads of the main body and detachably engage the tip member to the main body; and wherein said stem member is configured to form a valve with the second tip open end to prevent escape of fluid when the spray nozzle is in a closed position.

2. The device of claim 1, wherein said exterior threads and said inner threads are quad-lead threads.

3. The device of claim 1, wherein said first connector end carries a quick disconnect attachment to facilitate securing of the main body with the water hose.

4. The device of claim 1, wherein the fluid channel is defined between the inner wall of the tip member and the second outlet end of main body, and wherein the exit ports are in fluid communication with the fluid channel.

5. The device of claim 1, wherein a closing member is formed in a forwardmost portion of the stem member.

6. The device of claim 5, wherein the stem member is provided with a first circumferential groove formed in a location between the exterior threads and the exit ports and a second circumferential groove formed between the closing member and the exit ports, and wherein a sealing member is fitted in the first circumferential groove and the second circumferential groove.

7. The device of claim 6, wherein said stem member is provided with a reduced diameter portion, and wherein the exit ports are formed in the reduced diameter portion.

8. The device of claim 7, wherein the closing member is unitary connected to the reduced diameter portion.

9. The device of claim 5, wherein the inner wall of the tip member comprises a first substantially cylindrical part, a second conical part, an inwardly oriented closing lip and an outwardly flaring part uniformly connected to the closing lip.

10. The device of claim 9, wherein the closing lip is defined by a part of the inner wall extending in a substantially parallel relationship to a longitudinal axis of the tip member, said closing lip defining a pre-determined pattern of the fluid flow from the second tip open end.

11. The device of claim 9, wherein the outwardly flaring part is contoured to define a pre-determined spray pattern of the fluid flow from the second tip open end.

12. The device of claim 9, wherein the hollow body of the tip member comprises a conical portion, and wherein the outwardly flaring part is formed in the conical portion.

13. The device of claim 1, wherein the tip member is configured to frictionally engage said stem member substantially enclosing a major part of the stem member.

14. The device of claim 1, wherein a first gripping portion is formed on an exterior surface of the main body and a second gripping portion is formed on the exterior surface of the main body a distance from the first gripping portion.

15. The device of claim 14, wherein the first gripping portion and the second gripping portion is each provided with friction-increasing ridges and grooves.

16. The device of claim 1, wherein the tip member comprises a gripping part formed on an exterior surface, said gripping part having friction-increasing ridges and grooves.

17. A spray nozzle device attachable to a water hose or the like, comprising:
a main body having a central opening extending therethrough, said body having a first connector end configured for attachment to the water hose and establishing fluid communication between the water hose and the central opening, a second outlet end, and a stem member formed between the first connector end and the second outlet end, said stem member being provided with a plurality of circumferentially spaced exit ports formed in fluid communication with the central opening, an exterior surface of the main body carrying a plurality of exterior quad-lead threads;
a tip member comprising a hollow body having a first tip open end and a second tip open end, said hollow body defining a cavity, which extends from the first tip open end to the second tip open end defining a fluid channel in at least a part thereof, an inner wall of the hollow body forming an outlet fluid channel with the second outlet end, said inner wall carrying a plurality of inner quad-lead threads adjacent the first tip open end, said inner threads being configured to matchingly engage with the exterior threads of the main body and detachably engage the tip member to the main body; and wherein said stem member is configured to form a valve with the second tip open end to prevent escape of fluid when the spray nozzle is in a closed position.

18. The device of claim 17, wherein said first connector end carries a quick disconnect attachment to facilitate securing of the main body with the water hose.

19. The device of claim 17, wherein the tip member is configured to frictionally engage said stem member substantially enclosing a major part of the stem member.

20. The device of claim 17, wherein a first gripping portion is formed on an exterior surface of the main body and a second gripping portion is formed on the exterior surface of the main body a distance from the first gripping portion.

21. The device of claim 20, wherein the first gripping portion and the second gripping portion is each provided with friction-increasing ridges and grooves.

22. The device of claim 17, wherein the tip member comprises a gripping part formed on an exterior surface, said gripping part having friction-increasing ridges and grooves.

23. The device of claim 17, wherein a closing member is formed in a forwardmost portion of the stem member.

24. The device of claim 23, wherein the stem member is provided with a first circumferential groove formed in a location between the exterior threads and the exit ports and a second circumferential groove formed between the closing member and the exit ports, and wherein a sealing member is fitted in the first circumferential groove and the second circumferential groove.

25. The device of claim 24, wherein said stem member is provided with a reduced diameter portion, and wherein the exit ports are formed in the reduced diameter portion.

26. The device of claim 25, wherein the closing member is unitary connected to the reduced diameter portion.

27. The device of claim 17, wherein the inner wall of the tip member comprises a first substantially cylindrical part, a second conical part, an inwardly oriented closing lip and an outwardly flaring part uniformly connected to the closing lip.

28. The device of claim 27, wherein the closing lip is defined by a part of the inner wall extending in a substantially parallel relationship to a longitudinal axis of the tip member, said closing lip defining a pre-determined pattern of the fluid flow from the second tip open end.

29. The device of claim 28, wherein the outwardly flaring part is contoured to define a pre-determined spray pattern of the fluid flow from the second tip open end.

30. The device of claim 27, wherein the hollow body of the tip member comprises a conical portion, and wherein the outwardly flaring part is formed in the conical portion.
